(19) United States
(12) Patent Application Publication
(10) Pub. No.: US 2007/0255823 A1
(43) Pub. Date: Nov. 1, 2007

(54) Method for low-overhead message tracking in a distributed messaging system

(75) Inventors: Mark Astley, Wayne, NJ (US); Seung Jun, Atlanta, GA (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/416,013

(22) Filed: May 1, 2006

(51) Int. Cl. G06F 15/173

(52) U.S. Cl. 709/224

(57) ABSTRACT

A method for tracking a sent message in a distributed messaging system is presented. The method includes providing a sequence of data structures that when queried have a known probability of returning a false positive result and creating a message history by associating a range map with each of the sequence of data structures, where the range map includes a range of time stamps. The method further includes providing a message tracking ID corresponding to the sent messages, where the message tracking ID includes a client ID, a message time stamp that includes a bounded skew, and a server ID. The method further includes storing the message tracking ID in one of the sequence of data structures.

### TECHNICAL FIELD

The present invention relates generally to message tracking in a distributed messaging system, and more particularly to a system and method for tracking messages with low overhead with respect to the distributed messaging system's resources.

### BACKGROUND INFORMATION

In a distributed messaging system, one or more distributed message servers coordinate to route messages from message producers to message consumers.

A route includes an ordered sequence of message servers starting with a message server to which a message producer submits the message, and ending with a message server(s) that delivers the message to a message consumer(s). The route also includes a set of message servers responsible for forwarding the message from the message producer to the message consumer(s).

Message tracking is the process of recording the route of every message so that, at a later time, a system administrator may determine the route of one or more messages. The mode in which message routes are recorded is referred to as a tracking mode, and the mode in which message routes are recovered is referred to as a query mode. Depending on accuracy requirements, message routes recorded during tracking mode may be periodically stored to a storage device, such as a hard disk, so that system failures do not prevent the query mode from recovering routes.

Overhead refers to the additional system resource cost that tracking mode imposes on the distributed messaging system in terms of central processing unit (CPU) processing time, memory footprint, and required disk storage. Relative to the number of messages tracked, a low overhead tracking mechanism should have little or no measurable CPU overhead, a small memory footprint, and low disk storage requirements.

Known solutions to the problem of maintaining low overhead do not directly address message tracking, but instead provide similar capabilities by adapting unrelated mechanisms. For example, in existing systems, the system event log could be used to record the set of messages received by each messaging server (an indirect record of message routes). The main drawback of this approach is noticeable overhead and reduced performance when message rates reach non-trivial levels. Likewise, tracking techniques for tracking Internet Protocol (IP) packets, are primarily used as memory records of recent network traffic, however, and lack the ability to efficiently store tracking information so that routes are available in spite of failures, or at an arbitrary time after the message was tracked.

### SUMMARY OF THE INVENTION

The present invention relates generally to message tracking in a distributed messaging system, and more particularly to a system and method for tracking messages with low overhead with respect to the distributed messaging system's resources.

In one aspect, the invention involves a method for tracking a sent message in a distributed messaging system. The method includes: providing a sequence of data structures that when queried have a known probability of returning a false positive result, creating a message history by associating a range map with each of the sequence of data structures where the range map includes a range of time stamps, providing a message tracking ID corresponding to the sent messages where the message tracking ID includes a client ID, a message time stamp that includes a bounded skew, and a server ID, and storing the message tracking ID in one of the sequence of data structures.

In one embodiment, the method further includes querying the message history by using the message tracking ID to identify which of the sequence of data structures and associated range maps have a range of time stamps within which the message time stamp falls.

In another embodiment, the method further includes executing an inspection operation on the identified sequence of data structures and associated range maps that have a range of time stamps within which the message time stamp falls to determine if the message tracking ID is s stored therein.

In still another embodiment, the data structure includes a Bloom filter.

In yet another embodiment, the method further includes periodically storing to a data storage device the sequence of data structures and associated range maps.

In other embodiments, the method further includes configuring the accuracy of tracking the sent message by bounding the number of data structures which record the message in the sequence of data structures.

In still other embodiments, the method further includes defining a size of the data structure and thereby configuring the overhead for tracking the sent message.

In another aspect, the invention involves a program storage device readable by a machine, tangibly embodying a program of instructions executable by the machine to perform method steps for tracking a sent message in a distributed messaging system. The method steps include providing a sequence of data structures that when queried has a known probability of returning a false positive result, creating a message history by associating a range map with each of the sequence of data structures where the range map includes a range of time stamps, providing a message tracking ID corresponding to the sent messages where the message tracking ID includes a client ID, a message time stamp that includes a bounded skew, and a server ID, and storing the message tracking ID in one of the sequence of data structures.

In one embodiment, the method steps further include querying the message history by using the message tracking ID to identify which of the sequence of data structures and associated range maps have a range of time stamps within which the message time stamp falls.

In another embodiment, the method steps further include executing an inspection operation on the identified sequence of data structures and associated range maps that have a range of time stamps within which the message time stamp falls to determine if the message tracking ID is s stored therein.

In still another embodiment, the data structure includes a Bloom filter.

In yet another embodiment, the method steps further include periodically storing to a data storage device the sequence of data structures and associated range maps.

In other embodiments, the method steps further include configuring the accuracy of tracking the sent message by bounding the number of data structures which record the message in the sequence of data structures.

In still other embodiments, the method steps further include defining a size of the data structure and thereby configuring the overhead for tracking the sent message.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative schematic diagram of a computer network on which a distributed messaging system is implemented, according to one embodiment of the invention.

FIG. 2A is an illustrative block diagram of tracking operations during a production phase where a message producer submits a message to a message server, according to one embodiment of the invention.

FIG. 2B is an illustrative flow diagram of the tracking operation during the production phase shown in FIG. 2A.

FIG. 3A is an illustrative block diagram of tracking operations during a routing phase where a message server forwards a message to another message server, according to one embodiment of the invention.

FIG. 3B is an illustrative flow diagram of the tracking operation during the routing phase shown in FIG. 3A.

FIG. 4A is an illustrative block diagram of tracking operations during a delivery phase where a message server delivers a message to one or more message consumers, according to one embodiment of the invention.

FIG. 4B is an illustrative flow diagram of the tracking operation during the delivery phase shown in FIG. 4A.

FIG. 5 is an illustrative time diagram depicting the manner in which two producer tracking histories may overlap in the range of messages for which tracking information has been stored, according to one embodiment of the invention.

### DESCRIPTION

Introduction

The present invention relates generally to message tracking in a distributed messaging system, and more particularly to a system for tracking messages with low-overhead with respect to system resources, and is described in terms of a message tracking system which executes locally at every message server in the distributed messaging system.

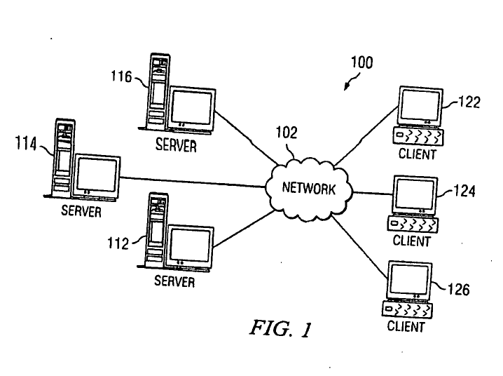

Referring to FIG. 1, in one embodiment, a schematic diagram of a computer network system 100 on which a distributed messaging system is implemented is shown. The computer network system 100 includes a network 102 (which may comprise internet, intranet, wired, or wireless, for example), message servers 112, 114, 116, and client computers 122, 124, and 12. Any client computer (PDA, mobile phone, laptop, PC, workstation, and the like) 122, 124, or 126 can function as a message producer (i.e., if it sends a message) or a message consumer (i.e., if it receives a message). The computer network system 100 may include additional message servers, client computers, and other devices not shown. In other embodiments, clients and servers can be located on the same physical hardware.

As previously described, in a distributed messaging system, one or more distributed message servers 112, 114, 116 coordinate to route messages from message producers (e.g., client computers 122, 124, and 126) to message consumers (e.g., client computers 122, 124, and 126). The message producers (client computers 122, 124, and 126) originate messages, and the message consumers (client computers 122, 124, and 126) receive routed messages.

A distributed messaging system is distinct from other network communication systems in that messages routed by the messaging system are discrete units of data (i.e., packets), rather than a continuous stream of data. Each message has one or more properties including a unique message ID, typically provided in a packet header. The unique message ID is a data structure including a unique producer ID (i.e. a unique number), a unique messaging server ID (i.e. a unique number), and a timestamp. The unique message ID distinguishes the message from every other message in the messaging system. Messages are originated by a single message producer (e.g., client 122, 124, or 126), but may be delivered to multiple message consumers (e.g., 122, 124, and/or 126. Message producers and message consumers are not directly connected and do not need to know about one another. Instead, the message servers 112, 114, 116 determine to which message consumers (client 122, 124, and/or 126) the produced messages are routed.

A message route includes an ordered sequence of message servers 112, 114, 116 starting with the message server (e.g., message server 112) that is in communication with the message producer (e.g., client 122) that submits the message, and ending with the message server(s) (e.g. message server 116) that delivers the message to the message consumer(s) (e.g., client 126). The message route also includes one or more message servers (e.g. message server 114) responsible for forwarding the message from the message producer 122 to the message consumer 126.

Within a distributed messaging system, a message is typically routed as follows. The message is created by a message producer (client 122, 124, or 126) and submitted to the messaging system for delivery. The message server 112, 114, or 116 that the message producer (client 122, 124, or 126) is in communication with receives the message and determines which local message consumers (client 122, 124, and/or 126) (if any) should receive the message, and which neighboring message servers 112, 114, 116 (if any) should receive the message. The message server 112, 114, 116 then routes the message to the appropriate local message consumers (client 122, 124, and/or 126) and neighboring messages servers 112, 114, 116. This process continues at each neighboring message server 112, 114, 116 until all appropriate message servers 112, 114, 116 and message consumers (client 122, 124, and/or 126) have received the message.

Using the unique identification of a message accepted for delivery, the message tracking system reports (to a system administrator, for example) the origin of the message (i.e., the particular message producer 122, 124, or 126 that sent the message), the message servers 112, 114, 116, which routed the message, and the clients (i.e., the message consumers 122, 124, and/or 126) that received the message.

The message tracking system includes a set of in-memory (located on the message server) and on-disk (located either on the message server, or external to the message server) data structures, a set of tracking algorithms, which store message routes in the data structures (discussed in detail below) and periodically transfer in-memory data to on-disk data, and a set of query algorithms, which recover routes from the data structures (either from in-memory or from on-disk).

In one embodiment, the in-memory and on-disk data structures are based on modified Bloom filters. Bloom filtering is a well-known technique for lossy compression of data and is described in “Space/Time Trade-offs in Hash Coding with Allowable Errors”, Bloom, B., Communications of the ACM, vol. 13, no. 7, pages 422-426, July 1970, the entirety of which is incorporated herein by reference. The invention involves making modifications to Bloom filters, which allow the Bloom filters to be organized into message histories. These message histories are the basis for recovering message routes during a query mode. Moreover, the message histories provide low overhead with respect to memory and disk usage by virtue of Bloom filter compressibility. The degree to which a history is lossy is configurable according to the distributed messaging system accuracy and reliability requirements. Messaging system accuracy and reliability refers to the maximum number of messages that may be lost due to a failure at a message server. For example, if a message server fails before storing in-memory message IDs to disk, then those message IDs are lost. The system administrator specifies the maximum number of messages that may be lost.

The tracking algorithms insert messages into the message histories in such a manner that message routes may be recovered in accordance with specified accuracy and reliability constraints. The cost of memory space per message is a small fraction of the size of the message ID (e.g., 10 percent). This cost is low compared to known solutions in which the cost per message equals the size of the message ID. Thus, the tracking algorithms provide low overhead with respect to memory utilization.

The complete message route of a particular message may be recovered by consulting the message histories at each message server 112, 114, 116 through which the message was routed. The invention defines a set of query algorithms that perform this task. The query algorithms are orthogonal to the tracking algorithms, which means they do not alter message histories and therefore do not affect tracking overhead.

The message tracking system minimizes tracking overhead by utilizing a fast, tunable, compressed message recorder at each message server 112, 114, 116. The message recorder is tunable such that accuracy and reliability of the distributed messaging system may be sacrificed for increased performance and scalability of the distributed messaging system. The compressed records managed by the recorder retain sufficient data to allow query mode operations at the specified accuracy and reliability levels.

Messaging System Modifications

In the preferred embodiment, each message producer (client 122, 124, 126), message consumer (client 122, 124, 126), and message server 112, 114, 116 has a unique system identification number assigned by the distributed messaging system. Message routes do not contain cycles. A cycle is a “loop” in the path from message producer to message consumer(s). More specifically, a route has a cycle if a message server routes a message more than once on the path from producer to consumer(s).

Messages transmitted between message servers 112, 114, 116 may be lost, but are not arbitrarily reordered or delayed. Each message server 112, 114, 116 maintains a local clock that is synchronized with every other message server 112, 114, 116 within a configurable skew. The skew is the difference between the local clocks on each pair of servers (i.e. the server the message is sent from and the server the message is sent to). The maximum allowable skew is a configuration parameter that is determined by system accuracy requirements.

In other embodiments, if the messaging system does not automatically assign unique identifiers, the underlying distributed messaging system is modified to assign unique identifications to producers, consumers, and message servers 112, 114, 116.

In the preferred embodiment, the messaging system does not allow cycles in the message routes. In other embodiments, if the messaging system does allow cycles in message routes, messages can be tagged to detect and ignore messages routed over cycles. Messages can be tagged with per-hop sequence numbers and time-stamps to detect and process reordered or delayed messages. In another embodiment, the system includes a network time daemon, which is a well known technique for synchronizing local clocks.

In still another embodiment, the invention involves modifying a client messaging service Application Program Interface (API) implementation so that a client ID, a message server ID, a local clock, and a skew correction are maintained by each client 122, 124, 126 (message producer or message consumer). The client ID is a unique fixed length client identification, which can be a number or a unique sequence of bytes. The message server ID is a unique fixed length identification of the message server 112, 114, 116 to which the client 122, 124, 126 is attached. The local clock is a monotonically increasing clock, which maintains local time. Unlike message server clocks, client clocks are not required to be synchronized. The skew correction is an integer correction value that is applied to the local clock when creating message time-stamps.

The client ID, the message server ID, and the skew correction fields are initialized when the client 122, 124, 126 (message producer or message consumer) connects to the messaging system for the first time. At run-time, the message server 112, 114, 116 may periodically send an updated skew correction to any local clients 122, 124, 126.

The message tracking system adds four fields to each message. These additional fields include a client ID field, a time-stamp field, a message server ID field, and a persistence interval field. The client ID field includes the client's unique ID. The message producer (client 122, 124, 126) sets this field when a new message is created. The time-stamp field includes a time-stamp, Tₘ, which is derived from the message producer's local clock plus the current skew correction just before the message is submitted to a message server 112, 114, 116. The message server ID field includes the unique ID of the message server 112, 114, 116 that is in communication with the message producer (client 122, 124, 126). The message producer (client 122, 124, 126) sets this field when a new message is created. The persistence interval field includes a time-stamp, Tₚ, which is used by the message servers 112, 114, 116 to periodically store tracking records, either on the particular message server 112, 114, 116 or on an external data storage device (e.g., hard disk). This field is set by the message server 112, 114, 116 that receives the message from the message producer (client 122, 124, 126).

The client ID (C), the message time-stamp (Tₘ), and the message server ID (S) are used to derive a message tracking ID, which is represented as (C, Tₘ, S). The message tracking ID is determined once the message producer (client 122, 124, 126) has assigned a time-stamp Tₘ just prior to submitting the message to the message server 112, 114, 116 for delivery.

Bloom Filter Histories

A Bloom filter is a well-known data structure that allows approximate set membership queries over a set of n elements called keys. The filter includes an m-bit array with k hash functions. Each hash function maps a key to one of the m bits in the array. The set of possible keys may be larger than m. In this case, the hash function may map two keys to the same bit in the m-bit array. If f is a hash function and P1, P2 are keys such that f(p₁)=f(p₂), then p₁ and p₂ are said to “collide”.

A Bloom filter supports three operations including add(p), contains(p), and capacity( ). The add(p) operation includes adding the key p to the set of elements stored in the Bloom filter. The contains(p) operation returns a “true” flag if the key p is stored in the filter and “false” flag otherwise. The capacity( ) operation returns the number of keys which can be stored in the Bloom filter within the required accuracy.

If f₁, . . . ,fₖ are the k hash functions for a Bloom filter, and m[i] is the ith element of the m-bit array where each m[i] is initialized to zero (0). Further, given a key p, the add(p) operation is implemented as shown below.

The element m[fᵢ(p)] is set equal to 1 for each fᵢ=f₁, . . . ,fₖ. Likewise, the contains(p) operation returns a “true” if and only if m[fᵢ(p)]=1 for each fᵢ=f₁, . . . ,fₖ, and returns a “false” otherwise. Note that a Bloom filter only records set membership. Given a Bloom filter, in general, it is not possible to recover the set of keys stored in the Bloom filter. The only way to recover the set of stored keys is to test the set of ALL possible keys (e.g. invoke contains(p) on every possible key p). This is not feasible for any non-trivial key set (e.g. the set of all possible message IDs).

A Bloom filter is efficient because the hash functions typically execute in constant time and because the storage space is compressed by the hash functions. However, because two keys may collide for a given hash function, a Bloom filter is subject to false positives and may incorrectly return “true” for the contains(p) operation when p was not actually stored in the Bloom filter. The probability of a false positive occurring depends on k, m, and n, where n is the number of elements that have been stored in the Bloom filter. Given, k, m, and n, the false positive probability (fpp) is determined by the following equation.
fpp=(1−(1−1/m)^{kn})^{k}

Thus, given a desired fpp, an appropriate k, m, and maximal n can be determined.

The present invention extends classic Bloom filters by associating a “range map” with each Bloom filter. A range map is a range R of the form [tₘ,tₙ], where tₘ and tₙ are time-stamps such that tₘ is less than or equal to tₙ. Initially, R=[ ]. An UpdateRange(t) operation is executed by the message server during tracking mode to update a range map, and is shown below.

If R=[ ], then the UpdateRange(t) operation sets R=[t, t]. If R=[tᵢ, tⱼ], and if t is less than tᵢ, the UpdateRange(t) operation sets R=[t, tⱼ]. Otherwise, if t is greater than tⱼ, the UpdateRange(t) operation sets R=[tᵢ, t], otherwise, no change is made to the range map.

A Ranged Bloom Filter (RBF) is represented as (Bᵢ, Rᵢ, tᵢ), where Bᵢ represents a Bloom filter, Rᵢ represents the range map for Bᵢ, and tᵢ represents a local time-stamp denoting when the RBF was instantiated.

A Bloom filter history is a sequence of RBFs, (Bᵢ, Rᵢ, tᵢ), . . . , (Bⱼ, Rⱼ, tⱼ) such that tᵢ≦tᵢ₊₁≦ . . . ≦tⱼ. The sequence is called a history because keys stored in the triple (Bᵢ, Rᵢ, tᵢ) correspond to messages which were observed by the message server where the history is stored before those recorded in (Bᵢ₊₁, Rᵢ₊₁, tᵢ₊₁). In tracking mode, message tracking IDs are periodically recorded by the recorder on the message server into a current RBF for each history. Since RBFs have a fixed capacity (according to the desired fpp of the Bloom filter component of each RBF), the current RBF in each history is periodically stored to disk and replaced with a new, empty RBF.

At query time, it is determined whether the message tracking ID Tr=(C, Tₘ, S) occurs in a particular Bloom filter history (B₁, R₁, t₁), . . . , (Bₙ, Rₙ, tₙ). A history is queried by using Tr to determine a key, p, and the message time-stamp, Tₘ. The key p depends on which history is being queried. For routing histores, p=C+Tₘ, and for consumer histories, p=C+Tₘ+L, where L is a consumer ID. Given p and Tₘ, a matching set, M(Tr)={(Bᵢ, Rᵢ, tᵢ): Tₘ in Rᵢ}, for Tr is the set of all RBFs (Bᵢ, Rᵢ, tᵢ) where Tₘ is in the range denoted by Rᵢ. The matching set determines which RBFs must be inspected to determine whether m was recorded in the history.

The effective false positive probability (efpp) is the probability that at least one of the RBFs in the matching set, M(Tr), will indicate a false positive. If the size of M(Tr) is b, then efpp is determined by the following equation.
efpp=1−(1−fpp)^{b}

If b=1, then efpp=fpp, otherwise, efpp≧fpp. The efpp gives the overall accuracy of the tracking system and is a configuration parameter which is enforced by bounding matching set size, and is discussed in further detail below.

Bloom filter histories are used to construct the in-memory and on-disk data structures defined by the present invention. While the Bloom filter component provides low-overhead message tracking ID storage, tracking would not be possible without the extensions provided by RBFs. In particular, the RBF extensions make it feasible to recover sufficient information about the key set stored in a Bloom filter so that route queries are possible.

In another embodiment, instead of Bloom filters, any data structure that has a known probability of giving false positives can be used.

Tracking Mode

Tracking mode in the present invention refers to the operations necessary to record the route of a message so that the message can be retrieved at a later time. A tracking mode operation can be divided into three phases including a production phase, a routing phase, and a delivery phase.

The production phase includes the creation of the message by a message producer (e.g., client 122, 124, or 126) and the delivery of the message to a message server 112, 114, or 116 in communication with the message producer (client 122, 124, or 126). The routing phase includes the routing of the message from one message server 112, 114, 116 to one or more other message servers 112, 114, 116. The delivery phase includes the delivery of the message from a message server 112, 114, 116 to one or more message consumers (clients 122, 124, and/or 126).

For a particular message, the production phase occurs exactly once at a unique message server 112, 114, 116. This is the message server 112, 114, 116 that is in communication with the message producer (client 122, 124, and/or 126) that created the message. The routing phase occurs when the message server 112, 114, 116 determines that the message should be forwarded to one or more other message servers 112, 114, 116. The delivery phase occurs when the message server 112, 114, 116 determines that a message should be delivered to one or more message consumers (clients 122, 124, and/or 126). Tracking mode operations for a particular message are complete when all the message servers 112, 114, 116 that need to execute the delivery phase have completed that phase.

Algorithm Initial State

The tracking system component at each message server 112, 114, 116 uses various configuration parameters and data structures including skew tolerance, producer history, persistence interval, consumer histories, neighbor histories, server persistence intervals, a consumer attachment map, and a local clock.

The skew tolerance is a value, Tₛ, in milliseconds, which determines the maximum separation between the time-stamp of a message submitted by a local message producer (client 122, 124, and/or 126) and the message server's internal clock.

The producer history is a Bloom filter history, Hₚ, which records the message tracking IDs for messages sent by local message producers (client 122, 124, 126).

The persistence interval is a value, Tₚ, in milliseconds, which determines the elapsed time between the persistence of the local message producer history.

The consumer histories are a set of Bloom filter histories indexed by a message server ID. The consumer history H_{c,S} records the message tracking IDs for messages received from message server S (e.g., message server 112) that were delivered to a local message consumer (e.g., client 122, 124, or 126).

The neighbor histories are a set of Bloom filter histories indexed by message server ID. The neighbor history H_{n,S} records the message tracking IDs for messages received from message server S (message server 112).

The server persistence intervals are a set of values, T_{p,S}, each in milliseconds, where the value T_{p,S} gives the persistence interval, Tₚ, for the message server S (message servers 112).

The consumer attachment map is a data structure that maintains the set of client IDs for all local message consumers (clients 122, 124, 126) and a local time-stamp indicating when the membership (i.e., the set of consumers currently in communication with the server) last changed.

The local clock is a value, T_{current,} which indicates the current local time at the message server S (message server 112).

These parameters and data structures are initialized when the message server S (e.g., message server 112) is created for the first time. Note that the consumer or neighbor history entry (and also the server persistence interval entry) for a particular message server S (e.g., message server 112) is not created until a message is received from that message server S (e.g., message server 112). Producer, consumer, and neighbor histories are made resilient to failure by periodically storing them to disk as described below. Consumer attachment maps are made resilient to failure by being stored to disk each time membership changes. Specifically, when the current set of message consumers (clients 122, 124, 126) changes, a new time-stamp is created and the consumer attachment map (and time-stamp) are stored to disk.

The preferred embodiment does not proscribe a particular mechanism for storing consumer attachment maps, although a variety of well known techniques may be applied to suit the frequency of consumer attachment map changes. All remaining server configuration is recoverable and need not be made resilient to failure. The initial values for skew tolerance and persistence interval are configurable according to system tuning requirements and are discussed in detail below. Further, the parameters for each RBF in each history (i.e. choices of m, k and n) are also configurable according to tuning requirements.

Production Phase

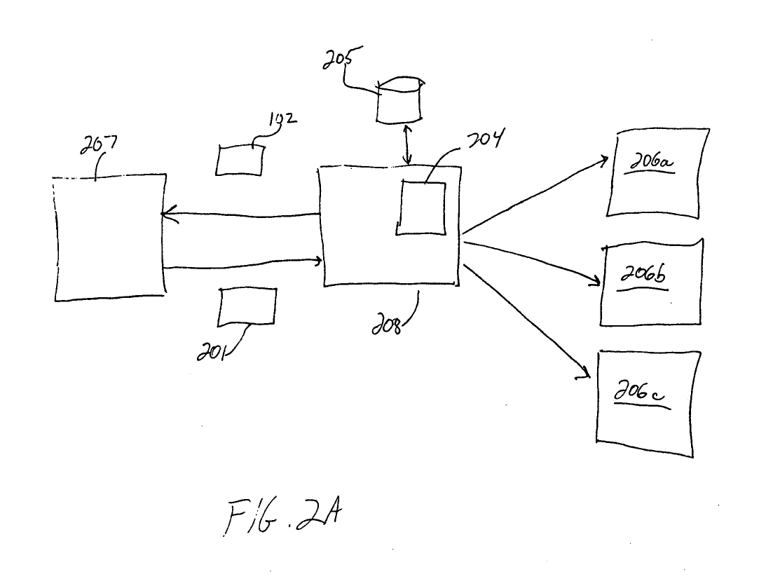

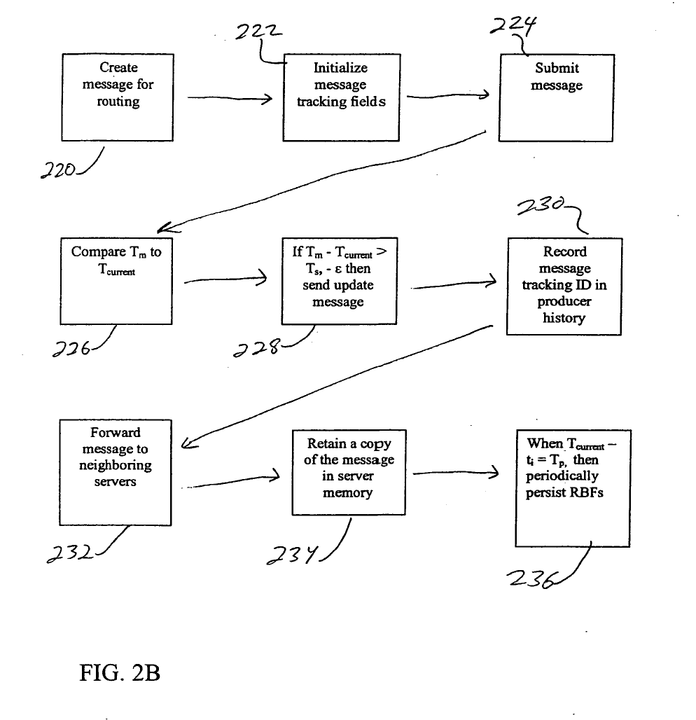

Referring to FIGS. 2A and 2B, in one embodiment, message tracking begins when a message producer C 207 creates a message for routing (Step 220). The message tracking fields in the message are initialized as described above (Step 222). The message producer C 207 then submits the message, m=(C, Tₘ, S) 201, to the message server S 208 that it is in communication with (Step 224).

When the message 201 arrives from the message producer C 207, the message server S 208 compares the value for Tₘ (time-stamp of the message) to T_{current} (Step 226). If the difference between Tₘ and T_{current} is greater than the skew tolerance, Tₛ, minus a small configured “headroom” parameter, ε, then the message server S 208 sends an update message 203 back to the message producer C 207 to adjust the message producer's skew correction (Step 228).

The message producer's skew correction is adjusted by (|Tₘ−T_{current}|−Tₛ−2ε)*SGN, where SGN is −1 if Tₘ>T_{current}, and 1 otherwise. The value for ε is the maximum expected latency between any local message producer (message produce C 207, for example) and the message server S 208. Skew correction updates ensure that the time-stamp attached to messages 201 from the message producer C 207 will not violate the skew tolerance of the message server S 208. Skew tolerance is the allowable difference in timestamps between messages from two different producers in communication with the same message server. This is a configuration parameter derived from the accuracy requirements of the messaging system. This property is necessary to ensure that the number of RBFs in M(Tr) (for any Tr) is never larger than some integer bound B according to configured accuracy requirements and is described in further detail below.

The message server S 208 records the message tracking ID in a message producer history 204, Hₚ, as follows (Step 230). Let p=C+Tₘ, (the byte concatenation of the client ID and the time-stamp). Let (Bᵢ, Rᵢ, tᵢ) be the current RBF in Hₚ. The following algorithm is executed by the message server S 208 to record the message tracking ID.
1. Invoke the Add(p) operation on the bloom filter Bᵢ and invoke the UpdateRange(Tₘ) operation on the range map Rᵢ.
2. If Bᵢ contains Bᵢ.capacity( ) (i.e., invoke the capacity( ) operation on the bloom filter Bᵢ) elements:
   (a) Persist (Bᵢ, Rᵢ, tᵢ) to a disk 205.
   (b) Instantiate the next RBF (Bᵢ₊₁, Rᵢ₊₁, T_{current}) in Hₚ (message producer history 204).

The second step in the above algorithm ensures that the current filter is always persisted when the filter is full. This is necessary to ensure the required fpp for each filter.

Once the message tracking ID has been recorded (in memory on the message server N 208 or on an external data storage device), the message server S 208 attaches the local persistence interval, Tₚ, and forwards the message 201 to the appropriate neighboring message servers 206a, 206b, and/or 206c (Step 232). A copy of the message 201 is retained in a memory on the message server S 208 in case any other local clients (not shown) are supposed to receive the message 201 (Step 234).

When T_{current}−tᵢ=Tₚ, where tᵢ is the instantiation time for the current RBF in Hₚ, then the following algorithm is executed by the message server S 208.
1. Persist (Bᵢ, Rᵢ, tᵢ) to the disk 205.
2. Instantiate the next RBF (Bᵢ₊₁, Rᵢ₊₁, T_{current}) in Hₚ (message producer history 204).

The above algorithm steps ensure that RBFs are periodically persisted (for reliability considerations) in case the message producer C 207 sends a message 201 at a low rate (Step 236).

Routine Phase

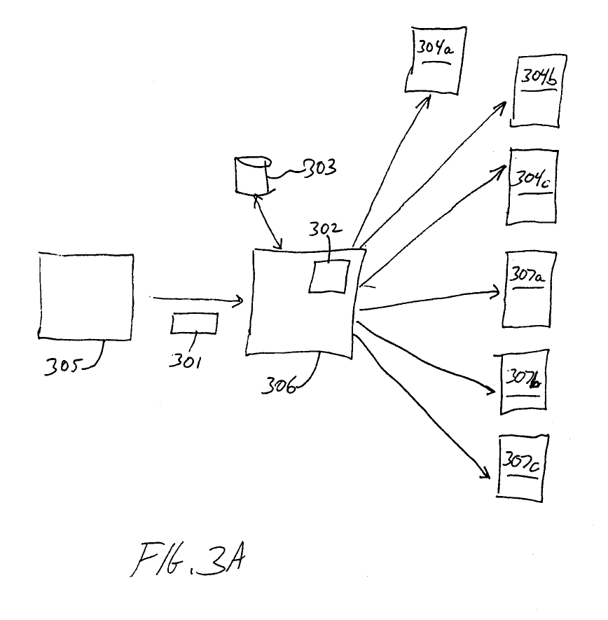

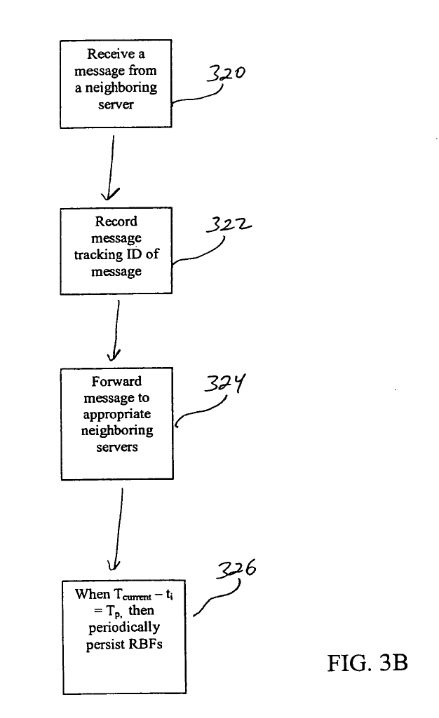

Referring to FIGS. 3A and 3B, in the routing phase, after a message server N 306 receives a message 301 from a neighboring message server 305 (Step 320), the message server 305 records the message tracking ID of the message 301 (Step 322). The message tracking ID is recorded in a producer history associated with the message server S 208 that originated the message.

In the message Tr=(C, Tₘ, S, Tₚ, s) 301 that is sent to the message server N 306 from the neighboring message server 305, C represents the client ID of the message producer C 207 (FIG. 2A) which created the message, Tₘ represents the message time-stamp, S represents the message server S 208 that originated the message (and is in communication with the message processor C 207), and T_{p,S} represents the local persistence interval for message server S 208.

The message server N 306 records the message tracking ID in the producer history H_{n,S} 302, as follows. Let p=C+Tₘ, which is the byte concatenation of C and the time-stamp. Let (Bᵢ, Rᵢ, tᵢ) be the current RBF in the producer history H_{n,S} 302. The following algorithm is executed by the message server N 306 to record the message tracking ID.
1. Invoke the Add(p) operation on the bloom filter Bᵢ and invoke the UpdateRange(Tₘ) operation on the range map Rᵢ.
2. If Bᵢ contains Bᵢ.capacity( ) (i.e., invoke the capacity( ) operation on the bloom filter Bᵢ) elements:
   (a) Persist (Bᵢ, Rᵢ, tᵢ) to a disk 303.
   (b) Instantiate the next RBF (Bᵢ₊₁, Rᵢ₊₁, T_{current}) in H_{n,S} 302.

The second step of the above algorithm ensures that the current filter is always persisted when the filter is full. This is necessary to ensure the required fpp for each filter.

Once the message tracking ID has been recorded (in memory on the message server N 306 or on an external data storage device), the message server N 306 forwards the message 301 to the appropriate neighboring servers 304a, 304b, and/or 304c (Step 324). A copy of the message is retained in memory in case any local clients 307 are supposed to receive the message 301.

When T_{current}−tᵢ=T_{p,S}, where tᵢ is the instantiation time for the current RBF in H_{n,S} 302, then the following algorithm is executed by the message server N 306.
1. Persist (Bᵢ, Rᵢ, tᵢ) to disk 303
2. Instantiate the next RBF (Bᵢ₊₁, Rᵢ₊₁, T_{current}) in H_{n,S} 302.

The above algorithm ensures that RBFs are periodically persisted (for reliability considerations).

Delivery Phase

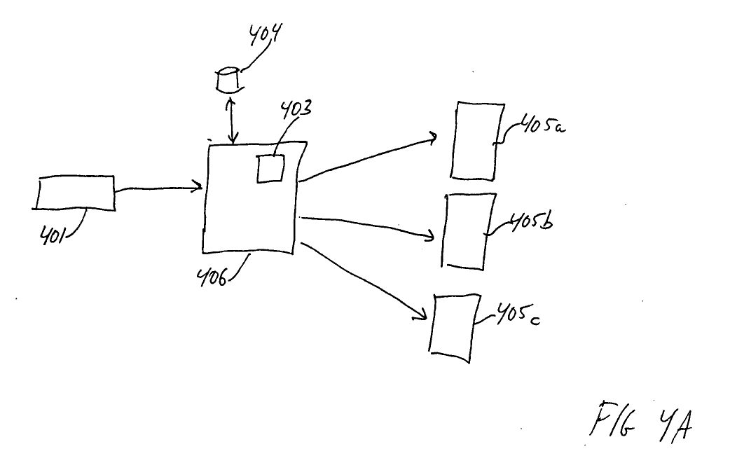

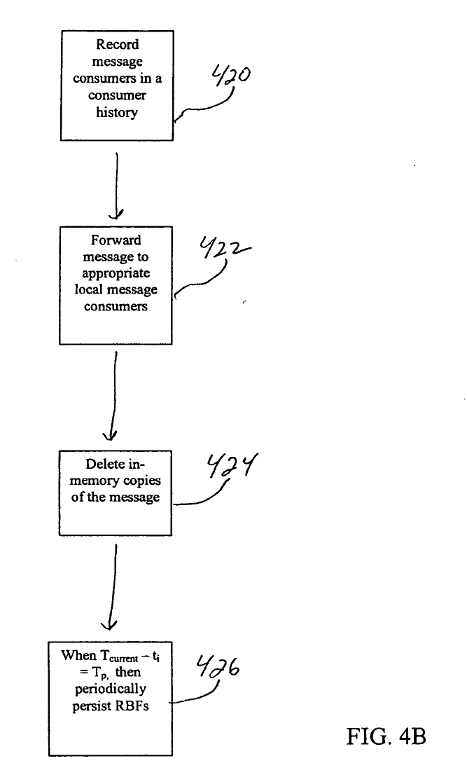

Referring to FIGS. 4A and 4B, in one embodiment, in the delivery phase, a set of local message consumers 405a, 405b, 405c that will receive a message 401 are recorded in a consumer history 403 (Step 420). The consumer history 403 can be stored either on the message server E 406, or on an external data storage device. One history entry is created for each client (message consumer 405a, 405b, 405c) that will receive the message 401. The message 401 may have arrived from a local message producer (not shown), or from a neighboring message server 406.

The message server E 406 receives the message Tr=(C, Tₘ, S, T_{p,S}) 401, where C represents the client ID of the message producer 207 which created the message 401, Tₘ represents the message time-stamp, S represents the message server S 208 which originated the message 401, and T_{p,S} is the local persistence interval for message server S 208. Again, message consumers 405a, 405b, and 405c are the set of local consumers that will receive the message 401 and H_{c,S} is the consumer history 403 for the message server S 208.

The message server E 406 creates a history entry for each message consumer Lⱼ, 405a, 405b, 405c, as follows. Let p=C+Lⱼ+Tₘ, which is the byte concatenation of C, Lⱼ and the time-stamp. Let (Bᵢ, Rᵢ, tᵢ) be the current RBF in H_{c,S} 403. The following algorithm is executed by the message server E 406 to record the message tracking ID.
1. Invoke the Add(p) operation on the bloom filter Bᵢ and invoke the UpdateRange(Tₘ) operation on the range map Rᵢ.
2. If Bᵢ contains Bᵢ.capacity( ) (i.e., invoke the capacity( ) operation on the bloom filter Bᵢ) elements:
   (a) Persist (Bᵢ, Rᵢ, tᵢ) to a disk 304.
   (b) Instantiate the next RBF (Bᵢ₊₁, Rᵢ₊₁, T_{current}) in H_{c,S} 403.

The second step in the above algorithm ensures that the current filter is always persisted when the filter is full. This is necessary to ensure the required fpp for each filter.

Once the message tracking ID has been recorded, the message server E 406 forwards the message 401 to the appropriate local message consumers 405a, 405b, 405c (Step 422). Any in-memory copy of the message 401 can be deleted at this point (Step 424).

When T_{current}−tᵢ=T_{p,S}, where tᵢ is the instantiation time for the current RBF in H_{c,S}, 403 then the following algorithm is executed by the message server E 406.
1. Persist (Bᵢ, Rᵢ, tᵢ) to the disk 404.
2. Instantiate the next RBF (Bᵢ₊₁, Rᵢ₊₁, T_{current}) in H_{c,S} 403.

The above algorithm ensures that RBFs are periodically persisted (for reliability considerations).

Accuracy, Overhead and Tuning

The following sections describe how the tracking mode operations are configured to guarantee a particular level of accuracy, the resultant overhead for a particular tracking mode configuration, and methods of tuning tracking mode to achieve a particular accuracy versus overhead tradeoff.

Accuracy

A system administrator selects particular accuracy levels by setting various parameters including efpp, FC_{S}, and PR_{S}.

The efpp is the effective false positive probability, which determines the probability of a history returning a false positive when querying a message tracking ID. This value is identical for all message servers.

FC_{S} is the filter capacity for the producer history filters at message server S 208. Maximum filter capacity settings are limited by choice of efpp. This value may be unique for each message server (S 208, N 306, E 406, neighboring server 304, 305), but must be known by every other message server (S 208, N 306, E 406, neighboring server 304, 305).

PR_{S} is the expected aggregate message rate for all message producers (e.g., message producer C 207) in communication with message server S 208. This parameter determines how quickly filters will exceed their capacity. Maximum aggregate message rates are limited by choice of efpp. This value may be unique for each message server (e.g., S 208, N 306, E 406, neighboring server 304, 305), but must be known by every other message server (e.g., S 208, N 306, E 406, neighboring server 304, 305).

The remaining tracking mode settings are determined automatically from these parameters. The required false positive probability, fpp, for an RBF can be determined from the efpp and the expected size of matching sets. The tracking mode algorithms ensure that matching set size is never greater than two. This implies that the false positive probability for all RBFs is determined by the following equation.
fpp=1−\sqrt{1−efpp}

Given FC_{S} and PR_{S} for a server S, T_{p,S}=FC_{S}/PR_{S}−α, and Ts,S=T_{p,S}/4, where T_{p,S} is the persistence interval for server S, T_{s,S} is the skew tolerance, and α is a small configurable value. For any other message server Q≠S, the value of FC_{S} is used to determine the filter capacity for the routing and consumer histories for message server S 208. The capacity for the routing history is exactly FC_{S}. The capacity for consumer histories is computed as described below.

If matching set size cannot be bound, then a particular efpp cannot be guaranteed. The present invention guarantees a bound using the novel approach of bounding maximum skew. That is, the value for T_{p,S} ensures that a filter will be persisted before its capacity is exceeded. The value for T_{s,S} ensures that a matching set never contains more than two RBFs. A matching set with a size greater than one occurs when a message tracking ID recorded in an RBF has a time-stamp that overlaps with a range in a previous (or subsequent) RBF.

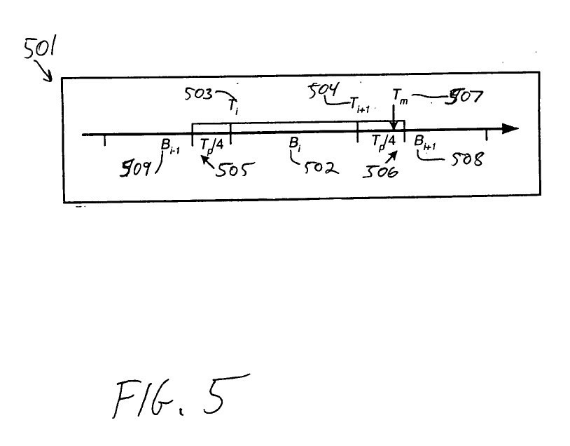

Referring to FIG. 5, in one embodiment, a message producer history timeline 501 is shown. Bᵢ 502 denotes the local time extent of a previously persisted Bloom filter with a starting local time Tᵢ 503, and an ending local time Tᵢ₊₁ 504 such that Tᵢ₊₁−Tᵢ≧Tₚ. The time-stamps contained in the range map for Bᵢ 502 may extend beyond Tᵢ 503 and Tᵢ₊₁ 504 (since message producer clocks are not tightly synchronized with the message server), but are bounded by Tᵢ−T_{p/}4 505 and Tᵢ₊₁+Tₚ/4 506 since any message in the interval Bᵢ could not have arrived before local time Tᵢ or after local time Tᵢ₊₁, and the skew tolerance bounds the maximum skew at Tₚ/4. Next, a message Tr=(C, T, S) arrives at local time Tₘ>Tᵢ₊₁ 507 with time-stamp T. This message will be recorded in the portion of the timeline associated with filter Bᵢ₊₁ 508. However, to ensure our matching set bound it must be verified that, at worst, the message will appear in both the range map for Bᵢ and the range map for Bᵢ₊₁. If T>Tᵢ₊₁+Tₚ/4 then the message can not appear in the range map for Bᵢ and, at worst, the message may appear in the range map for Bᵢ₊₂. If T≦Tᵢ₊₁+Tₚ/4 then the message may appear in the range map for Bᵢ, but we must ensure that T≧Tᵢ+Tₚ/4 so that it is not possible for the message to overlap with Bᵢ₋₁ 509. Since the length of the interval for Bᵢ is at least Tₚ,
Tᵢ+Tₚ≦Tᵢ₊₁=>
Tᵢ+Tₚ−3Tₚ/4≦Tᵢ₊₁−3Tₚ/4 =>
T_{i +T}ₚ/4≦Tᵢ₊₁−3Tₚ/4≦Tᵢ₊₁−Tₚ/4≦Tₘ−Tₚ/4≦T
where the last equation follows since Tₘ≧Tᵢ₊₁ and the skew requirement asserts that Tₘ−Tₚ/4≦T≦Tₘ+Tₚ/4. Thus, in the worst case, the message may appear in the range map for both Bᵢ and Bᵢ₊₁, yielding a maximum matching set of two.

Now consider a stream of messages from a message server Sₙ arriving at some other message server Sₘ. Since it is assumed that messages are not arbitrarily reordered, and that server clocks are roughly synchronized, then the basic skew requirements are maintained plus some minor correction factor, e, which reflects the difference in clocks for Sₙ and Sₘ, and a minimum routing delay, c, which reflects the routing latency from Sₙ to Sₘ. In other words, if a message arrives at local time Tₙ at Sₙ, then the message will arrive at Sₘ no earlier than Tₘ=Tₙ+e+c. Likewise, the interval [Tᵢ, Tᵢ₊₁] at Sₙ corresponds to the interval [Tᵢ*, Tᵢ₊₁*] at Sₘ where Tᵢ*=Tᵢ+e+c and Tᵢ₊₁*=Tᵢ₊₁+e+c. Thus, the same reasoning applies as in the producer case since Tᵢ₊₁*−Tᵢ*≧Tₚ (since Tᵢ₊₁−Tᵢ≧Tₚ) and Tₘ≧Tᵢ₊₁*, we must have Tₘ≧Tᵢ*+Tₚ/4 which guarantees that at worst the message is in the range map for both Bᵢ and Bᵢ₋₁, at Sₘ. This bounds the matching set at message servers other than where the message originated.

Typically, a consumer history will include many more entries than a producer or neighbor history because the consumer history stores a message once for each local message consumer (e.g., message consumer 405a, 405b, 405c) that receives the message. In order to maintain a bound on matching set size, consumer histories must be proportionately larger than producer or neighbor histories so that Tₚ is still a lower bound on the rate at which consumer histories are filled. In particular, if Tₚ is the bound for a particular server, n is the maximum number of messages which can arrive from a message server (e.g., message server E 406) in interval Tₚ, and m is the maximum number of message consumers which may wish to consume each message arriving from the message server, then each consumer history filter must be capable of storing m * n elements. This ensures that Tₚ is a lower bound on the consumer history fill rate and a message will overlap in range with at most two consumer history elements. Note that n is just FC_{S}, which is known at configuration time, as is Tₚ (see above). Hence, at configuration time, the consumer history can be defined to allow m*FC_{S} elements.

Overhead

Overhead is the per-message cost tracking mode operations impose on CPU, memory, and disk resources at each message server. There are three sources of overhead in tracking mode, which include filter insertion, filter persistence, and phase processing.

Filter insertion involves recording the tracking ID for each message into at most three histories at each message server. The cost of a single insertion into a history is the cost of the “add” operation on an RBF. This cost is proportional to the time required to evaluate the k hash functions configured for the RBF. This cost is roughly constant since key sizes are bounded (at worst the size of two client IDs concatenated with a time-stamp) and hash function evaluation is constant if key size is constant (recall that client IDs are fixed size).

Filter persistence involves storing an RBF to disk when it reaches its capacity. The disk storage cost is constant since RBF capacities are constant.

In phase processing, a message server spends time executing at most three tracking mode phases. In a production phase, non-filter operations consume constant time because no history resolution is necessary. In a routing phase, non-filter operations consume constant time since the message server must resolve at most one neighbor history for the message. In a delivery phase, non-filter operations consume constant time since the message server must resolve at most one consumer history, but multiple filter insertions may be performed in proportion to the number of consuming clients.

Filter insertion overhead occurs each time a message tracking ID is inserted into a history. The production and neighbor phases contribute one insertion each, per message. The consumer phase contributes one insertion for each consuming client. Thus, filter insertion introduces constant overhead with respect to non-tracking processing since, even in the case of consumer processing, the message server will consume resources proportional to the number of consuming clients.

Filter persistence overhead occurs at a rate proportional to Tₚ for each server. Amortized over messages, this results in constant overhead per message because filter persistence overhead is constant.

Finally, phase processing overhead occurs each time a message is processed by a message server. As with filter insertions, production and neighbor phases contribute only constant overhead, while the delivery phase contributes overhead proportional to the number of consuming clients. As a non-tracking message server consumes resources proportional to the number of consuming clients, the overall phase processing overhead is constant per message.

Tuning

A distributed messaging system administrator may trade accuracy for lower overhead by adjusting efpp, or by controlling the non-tracking related parameter, CS, which gives the maximum number of message consumers that may consume a message from a message server.

Larger values for efpp result in substantial space and time improvements at the cost of lower accuracy. A given efpp fixes the available choices for the number of hash functions and the size of the filter array, which in turn fixes the maximum capacity of a filter. A larger efpp allows fewer hash functions to be used on larger filters, which in turn allows for larger persistence intervals. Fewer hash functions impose less constant overhead on per-message tracking operations. Likewise, a larger persistence interval lowers the amortized message cost imposed by periodically persisting filters.

The value for CS determines the size of consumer history filters and the maximum number of entries created in delivery mode. A lower value of CS thus reduces the overhead incurred in delivery mode (i.e. fewer filter insertions) as well as the amortized message cost for persistence (i.e. storing smaller filters to disk), at the cost of supporting less consuming clients per message server.

Query Mode

Referring again to FIG. 2A, query mode in the present invention refers to those operations necessary to recover the route of a particular message given the message tracking ID Tr=(C, Tₘ, S). Note that by construction, it is known that message producer C 207 created the message 201 and that the message 201 originated at message server S 208. A query begins by initializing the following query state.

Bᵣ is the set of message servers that routed the message, and is initially set to { }.

B_{c} is the set of message servers that delivered the message to a consumer, and is initially set to { }.

Cᵣ is the set of IDs of message consumers to which the message was delivered, and is initially set to { }.

Bₐ is initially the set of all message servers in the messaging system.

The query begins at any arbitrary message server according to the following algorithm, with Bₓ being the current message server.
1. Set Bₐ=Bₐ−{Bₓ}.
2. Bₓ computes the local matching set by matching Tr against the routing history for message server S 208. If the matching set is non-empty, and the contains(p) operation returns “true” for at least one member of the set, then set Bᵣ=Bᵣ+{Bₓ}.
3. Bₓ computes the local matching set for the consumer history for message server S 208. If the matching set is non-empty, then:
   (a) The message server S 208 retrieves the consumer attachment map for the range covering time-stamp Tₘ. For each consumer, Cₓ, in the map, let p=C+Cₓ+Tₘ. Set Cᵣ=Cᵣ+{Cₓ} if contains(p) returns true in at least one member of the matching set.
   (b) If step (a) changed Cr, then set B_{c}=B_{c}+{Bₓ}.
4. If Bₐ≠{ }, set Bₓ to an arbitrary message server in Bₐ, otherwise terminate the query.

Upon termination, B_{c} gives the set of message consumers that the message was delivered to, and Bᵣ gives the set of message servers that routed the message. An ordered path from message server S 208 to each B_{c} (through each Bᵣ) may be constructed from the topology of the network. The set of such paths gives the route of the original message.

Under failure free conditions, the above algorithm is guaranteed to produce the actual route of the message with probability 1−efpp, and a superset of the actual route in all other cases. The route may be a superset because a history may indicate a false positive, causing a server to be added to the route that did not actually observe the message.

If one or more failures occur, a history filter including a record of Tr may fail to be recorded to disk. This may cause gaps in the recovered route, or fail to reproduce all of the consumers that received the message. Some gaps may be recovered from topology information. For example, if the topological path between two message servers includes a server that did not appear to observe the message, then it can be concluded with probability 1−efpp that the intermediate server failed before recording an observation of the message.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method for tracking a sent message in a distributed messaging system, the method comprising:
providing a sequence of data structures that when queried has a known probability of returning a false positive result;
creating a message history by associating a range map with each of the sequence of data structures, the range map comprising a range of time stamps;
providing a message tracking ID corresponding to the sent messages, the message tracking ID comprising a client ID, a message time stamp comprising a bounded skew, and a server ID; and
storing the message tracking ID in one of the sequence of data structures.

2. The method of claim 1 further comprising querying the message history by using the message tracking ID to identify which of the sequence of data structures and associated range maps have a range of time stamps within which the message time stamp falls.

3. The method of claim 2 further comprising executing an inspection operation on the identified sequence of data structures and associated range maps that have a range of time stamps within which the message time stamp falls to determine if the message tracking ID is stored therein.

4. The method of claim 1 wherein the data structure comprises a Bloom filter.

5. The method of claim 1 further comprising periodically storing to a data storage device the sequence of data structures and associated range maps.

6. The method of claim 1 further comprising configuring the accuracy of tracking the sent message by bounding the number of data structures which record the message in the sequence of data structures.

7. The method of claim 1 further comprising defining a size of the data structure and thereby configuring the overhead for tracking the sent message.

8. A program storage device readable by a machine, tangibly embodying a program of instructions executable by the machine to perform method steps for tracking a sent message in a distributed messaging system, the method steps comprising:
providing a sequence of data structures that when queried has a known probability of returning a false positive result;
creating a message history by associating a range map with each of the sequence of data structures, the range map comprising a range of time stamps;
providing a message tracking ID corresponding to the sent messages, the message tracking ID comprising a client ID, a message time stamp comprising a bounded skew, and a server ID; and
storing the message tracking ID in one of the sequence of data structures.

9. The method steps of claim 8 further comprising querying the message history by using the message tracking ID to identify which of the sequence of data structures and associated range maps have a range of time stamps within which the message time stamp falls.

10. The method steps of claim 9 further comprising executing an inspection operation on the identified sequence of data structures and associated range maps that have a range of time stamps within which the message time stamp falls to determine if the message tracking ID is s stored therein.

11. The method steps of claim 8 wherein the data structure comprises a Bloom filter.

12. The method steps of claim 8 further comprising periodically storing to a data storage device the sequence of data structures and associated range maps.

13. The method steps of claim 8 further comprising configuring the accuracy of tracking the sent message by bounding the number of data structures which record the message in the sequence of data structures.

14. The method steps of claim 8 further comprising defining a size of the data structure and thereby configuring the overhead for tracking the sent message.
